(19) United States
(12) Patent Application Publication
(10) Pub. No.: US 2024/0150568 A1
(43) Pub. Date: May 9, 2024

(54) HIGH THERMAL CONDUCTIVITY FLUORORESIN COMPOSITION AND PRODUCTS THEREOF

(71) Applicant: NAN YA PLASTICS CORPORATION, TAIPEI (TW)

(72) Inventors: Te-Chao Liao, TAIPEI (TW); Hung-Yi Chang, TAIPEI (TW); Chia-Lin Liu, TAIPEI (TW); Wei-Ru Huang, TAIPEI (TW)

(21) Appl. No.: 18/184,696

(22) Filed: Mar. 16, 2023

(30) Foreign Application Priority Data
Nov. 3, 2022 (TW) 111141993

(51) Int. Cl. C08L 27/18

(52) U.S. Cl. CPC C08L 27/18; C08L 2201/08; C08L 2205/025

(57) ABSTRACT

The invention provides a high thermal conductivity fluororesin composition and products thereof. The high thermal conductivity fluororesin composition includes a polytetrafluoroethylene resin, a fluorine-containing copolymer, spherical inorganic fillers and impregnation aids.

### CROSS-REFERENCE TO RELATED APPLICATION

This application claims the priority benefit of Taiwan application serial no. 111141993, filed on Nov. 3, 2022. The entirety of the above-mentioned patent application is hereby incorporated by reference herein and made a part of this specification.

### BACKGROUND

### Technical Field

The disclosure relates to a fluororesin composition and products thereof, and particularly relates to a high thermal conductivity fluororesin composition and products thereof.

### DESCRIPTION OF RELATED ART

In the 5G/B5G communication generation, due to the impact of high-speed transmission and miniaturization of the carrier board, the heat generated during signal transmission becomes a serious problem. Therefore, how to solve the large amount of heat loss generated under the millimeter wave communication is an urgent goal for those skilled in the art.

### SUMMARY

The disclosure provides a high thermal conductivity fluororesin composition and products thereof. By adding its heat channel path design, it becomes the cooling solution for antenna carrier board.

A high thermal conductivity fluororesin composition according to the disclosure includes a polytetrafluoroethylene resin, a fluorine-containing copolymer, spherical inorganic fillers and impregnation aids.

In an embodiment of the disclosure, the fluorine-containing copolymer includes a tetrafluoroethylene-perfluoroalkoxy vinyl ether copolymer, a perfluoroethylene propylene copolymer or a combination thereof.

In an embodiment of the disclosure, the spherical inorganic fillers include modified silica, aluminum silicate and boron nitride.

In an embodiment of the disclosure, a median particle size D50 of modified silica is 0.5 μm, a median particle size D50 of aluminum silicate is 4 μm to 6 μm, and a median particle size D50 of boron nitride is 40 μm to 50 μm.

In an embodiment of the disclosure, based on a total weight of the spherical inorganic fillers, a content of modified silica is 10 wt % to 20 wt %, a content of aluminum silicate is 20 wt % to 35 wt %, and a content of boron nitride is 20 wt % to 35 wt %.

In an embodiment of the disclosure, the impregnation aids include a wetting agent, a dispersant, a defoamer or a combination thereof.

In an embodiment of the disclosure, the impregnation aids include hydroxyethylcellulose, nitrocellulose, polymethylstyrene, polymethylmethacrylate, polyethylene glycol, or a combination thereof.

In an embodiment of the disclosure, based on a total weight of the fluororesin composition, a content of the polytetrafluoroethylene resin is 20 wt % to 35 wt %, a content of the fluorine-containing copolymer is 5 wt % to 15 wt %, a content of the spherical inorganic fillers is 65 wt % to 75 wt %, and a content of the impregnation aids is 0.5 wt % to 3 wt %.

A product according to the disclosure is made by performing a processing method with the fluororesin composition, and the processing method includes impregnation or coating.

In an embodiment of the disclosure, a thermal conductivity of the product is 1.3 W/mk or more.

Based on the above, the fluororesin composition according to the disclosure includes spherical inorganic fillers, which uses the ratio combination of modified silica, aluminum silicate and boron nitride with different particle sizes in spherical inorganic fillers to achieve the densest stacking. As a result, the number of thermal diffusion channels is maximized, so that the thermal conductivity in the Z-axis direction reaches a level above 1.3 W/mk.

### DESCRIPTION OF THE EMBODIMENTS

Hereinafter, embodiments of the disclosure will be described in detail. However, these embodiments are illustrative, and the disclosure is not limited thereto.

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with any numerical value and a smaller numerical range thereof in the specification.

The disclosure provides a high thermal conductivity fluororesin composition, which includes a polytetrafluoroethylene (PTFE) resin, a fluorine-containing copolymer, spherical inorganic fillers and impregnation aids.

In the present embodiment, the fluorine-containing copolymer may include tetrafluoroethylene-perfluoroalkoxy vinyl ether copolymer (PFA), perfluoroethylene propylene copolymer (FEP) or a combination thereof. The impregnation aids may include a wetting agent, a dispersant, a defoamer or a combination thereof. More particularly, the impregnation aids may include hydroxyethylcellulose, nitrocellulose, polymethylstyrene, polymethylmethacrylate, polyethylene glycol, or combinations thereof.

In the present embodiment, the spherical inorganic fillers include modified silica, aluminum silicate and boron nitride. A median particle size D50 of modified silica is 0.5 μm, a median particle size D50 of aluminum silicate is 4 μm to 6 μm, and a median particle size D50 of boron nitride is 40 μm to 50 μm. Based on a total weight of the spherical inorganic fillers, a content of modified silica is 10 wt % to 20 wt %, a content of aluminum silicate is 20 wt % to 35 wt %, and a content of boron nitride is 20 wt % to 35 wt %. The ratio of modified silica, aluminum silicate and boron nitride with different particle sizes in spherical inorganic fillers is used to achieve the densest stacking, thereby maximizing the number of thermal diffusion channels, so that the thermal conductivity in the Z-axis direction can reach a level above 1.3 W/mk and low electrical loss characteristics.

In the present embodiment, based on a total weight of the fluororesin composition, a content of the polytetrafluoroethylene resin is 20 wt % to 35 wt %, a content of the fluorine-containing copolymer is 5 wt % to 15 wt %, a content of the spherical inorganic fillers is 65 wt % to 75 wt %, and a content of the impregnation aids is 0.5 wt % to 3 wt %.

The disclosure also provides a product, which is made by performing a processing method with the fluororesin composition, and the processing method includes impregnation or coating. By adding spherical inorganic fillers to the fluororesin composition of the disclosure, the ratio of modified silica, aluminum silicate and boron nitride with different particle sizes in the spherical inorganic fillers is used to achieve the densest stacking, thereby maximizing the number of thermal diffusion channels, so that the thermal conductivity of the product is 1.3 W/mk or more.

Below, the above-mentioned high thermal conductivity fluororesin composition and products thereof of the disclosure are described in detail by experimental example. However, the following experimental examples are not intended to limit the disclosure.

### EXPERIMENTAL EXAMPLES

In order to prove that the fluororesin composition proposed by the disclosure is able to increase the thermal conductivity of the product and has low electrical loss characteristics, this experimental example is specially performed below.

Instrument Analysis

Dielectric constant Dk: Agilent Technology dielectric analyzer model no. E4991A is used to test the dielectric constant Dk at a frequency of 10 GHz.

Dielectric loss Df: Agilent Technology dielectric analyzer model no. E4991A is used to test the dielectric loss Df at a frequency of 10 GHz.

Glass transition temperature (t) is tested with a dynamic mechanical analyzer (DMA).

Thermal conductivity analysis test: use interface material thermal resistance and thermal conductivity measuring instrument, which meets ASTM D5470 specification.

Peel strength (lb/in): test the peel strength between copper foil and substrate with tensile testing machine.

Property analysis of the fluororesin composition and products thereof

The component ratio of fluororesin composition and test result are listed in following Table 1. In Table 1, the product is made of fluororesin composition, and the processing method may include methods such as impregnation or coating. The content unit in Table 1 is gram (g). The additive 4100 in Table 1 is TEGO® Twin 4100, which is a siloxane-based twin structure surfactant, with substrate wettability, anti-cratering performance and a certain degree of defoaming performance, good compatibility, and is suitable for wide variety of coatings and applications.

TABLE 1

| | | | Comparative | Comparative | Comparative | Comparative | Comparative |
|---|---|---|---|---|---|---|---|
| Material (g) | | Example 1 | example 1 | example 2 | example 3 | example 4 | example 5 |
| Polytetrafluoroethylene | | 100 | | | | | |
| resin | | | | | | | |
| Additive 4100 | | 2 | | | | | |
| PFA film | | ◯ | X | X | ◯ | ◯ | ◯ |
| PTFE film | | X | X | ◯ | X | X | X |
| Silicon | SC2500 | 54 | 0 | 0 | 0 | 0 | 0 |
| dioxide | spherical | | | | | | |
| | 503ARV | 0 | 54 | 54 | 0 | 30 | 54 |
| | flaky | | | | | | |
| Boron | SA35 | 108 | 108 | 108 | 0 | 0 | 108 |
| nitride | spherical | | | | | | |
| | PTX-25 | 0 | 0 | 0 | 34 | 40 | 0 |
| | flaky | | | | | | |
| Aluminum | 1466- | 108 | 0 | 0 | 0 | 0 | 0 |
| silicate | 600VST | | | | | | |
| Aluminum | S03 | 0 | 108 | 108 | 30 | 90 | 108 |
| oxide | S10 | 0 | 0 | 0 | 90 | 0 | 0 |

| | | | | | | |
|---|---|---|---|---|---|---|
| Thermal | 1.30 | 1.21 | 0.864 | 1.12 | 0.9 | 1.30 |
| conductivity(W/mk) | | | | | | |
| 10 G Dk | 3.2 | 3.41 | 3.42 | 3.46 | 3.2 | 3.45 |
| 10 G Df | 0.00135 | 0.00137 | 0.00133 | 0.00142 | 0.00137 | 0.00146 |
| Peel strength (Lb/in) | 4 | 2.61 | 5.59 | 3.73 | 2.98 | 3.73 |

As shown in Table 1, the fluororesin composition of Example 1 conforms to the composition and ratio proposed by the disclosure, so the thermal conductivity reaches the level of 1.3 W/mk and has low electrical loss characteristics. In contrast, Comparative Examples 1 to 5 use flaky inorganic fillers and do not use aluminum silicate of spherical inorganic fillers. Therefore, Comparative Examples 1 to 4 could not achieve thermal conductivity above 1.3 W/mk. Even though the thermal conductivity of Comparative Example 5 reaches 1.3 W/mk, it cannot achieve the advantage of the low electrical loss characteristic of the disclosure.

In sum, the fluororesin composition of the disclosure includes spherical inorganic fillers, which utilizes the ratio of modified silica, aluminum silicate and boron nitride in different particle diameters in spherical inorganic fillers to reach the densest stacking, and then maximizes the number of thermal diffusion channels. As a result, the heat conduction rate in the Z-axis direction reaches a level above 1.3 W/mk and has low electrical loss characteristics. In this way, the problem of a large amount of heat loss can be effectively improved.

What is claimed is:

1. A fluororesin composition, comprising:
a polytetrafluoroethylene resin;
a fluorine-containing copolymer;
spherical inorganic fillers; and
impregnation aids.

2. The fluororesin composition according to claim 1, wherein the fluorine-containing copolymer includes a tetrafluoroethylene-perfluoroalkoxy vinyl ether copolymer, a perfluoroethylene propylene copolymer or a combination thereof.

3. The fluororesin composition according to claim 1, wherein the spherical inorganic fillers include modified silica, aluminum silicate and boron nitride.

4. The fluororesin composition according to claim 3, wherein a median particle size D50 of modified silica is 0.5 μm, a median particle size D50 of aluminum silicate is 4 μm to 6 μm, and a median particle size D50 of boron nitride is 40 μm to 50 μm.

5. The fluororesin composition according to claim 3, wherein based on a total weight of the spherical inorganic fillers, a content of modified silica is 10 wt % to 20 wt %, a content of aluminum silicate is 20 wt % to 35 wt %, and a content of boron nitride is 20 wt % to 35 wt %.

6. The fluororesin composition according to claim 1, wherein the impregnation aids include a wetting agent, a dispersant, a defoamer or a combination thereof.

7. The fluororesin composition according to claim 1, wherein the impregnation aids include hydroxyethylcellulose, nitrocellulose, polymethylstyrene, polymethylmethacrylate, polyethylene glycol, or a combination thereof.

8. The fluororesin composition according to claim 1, wherein based on a total weight of the fluororesin composition, a content of the polytetrafluoroethylene resin is 20 wt % to 35 wt %, a content of the fluorine-containing copolymer is 5 wt % to 15 wt %, a content of the spherical inorganic fillers is 65 wt % to 75 wt %, and a content of the impregnation aids is 0.5 wt % to 3 wt %.

9. A product, made by performing a processing method with the fluororesin composition according to claim 1, and the processing method includes impregnation or coating.

10. The product according to claim 9, wherein a thermal conductivity of the product is 1.3 W/mk or more.
